(19) United States
(12) Patent Application Publication
(10) Pub. No.: US 2021/0200597 A1
(43) Pub. Date: Jul. 1, 2021

(54) INFORMATION PROCESSING DEVICE, INFORMATION PROCESSING METHOD, AND PROGRAM

(71) Applicant: Sony Corporation, Tokyo (JP)

(72) Inventors: Daisuke MOCHIZUKI, Tokyo (JP); Fuminori HOMMA, Tokyo (JP); Shosuke MOMOTANI, Tokyo (JP)

(73) Assignee: Sony Corporation, Tokyo (JP)

(21) Appl. No.: 16/981,282

(22) PCT Filed: Mar. 6, 2019
(86) PCT No.: PCT/JP2019/008769

§ 371 Date: Mar. 16, 2021

(30) Foreign Application Priority Data
Mar. 16, 2018 (JP) 2018-050185

(51) Int. Cl. G06F 9/50; G06F 3/16; G10L 15/22

(52) U.S. Cl. CPC G06F 9/5055; G06F 3/167; G10L 2015/223; G06F 9/5044; G10L 15/22

(57) ABSTRACT

It is an object of the present technology to make it possible to perform a process corresponding to user input satisfactorily.

An intention interpretation unit interprets intention of user input. A request corresponding to the interpreted intention is issued by a request issuing unit. A local processing control unit determines, on the basis of the issued request, whether a process corresponding to the request is to be executed by a local processing execution unit or by a cloud processing execution unit, and transmits, in a case where it is determined that the process is to be executed by the cloud processing execution unit, the request to a cloud processing control unit.

### TECHNICAL FIELD

The present technology relates to an information processing apparatus, an information processing method, and a program, and particularly to an information processing apparatus that is suitably applicable to speech agents, and the like.

### BACKGROUND ART

For example, it is conceivable that all the processes corresponding to user input are performed on the cloud side in the speech agent, but can be sufficiently coped with on the local side in some cases. Alternatively, it is favorable to perform the processes on the local side in some cases.

Further, in general, providing feedback by the output from a system to the user input is a key factor in realizing excellent user interfaces (UIs). However, in the voice UIs in which user input is performed by speech, it is important to feed back, at an early stage, the fact that the intended input has been received or has not been received, because uncertainties such as “accuracy of speech recognition” and “accuracy of semantic analysis” are included in the input process, as compared with the character input or the like.

For example, a voice UI (User Interface) framework in which an application (hereinafter, appropriately referred to as “app”) is started on the basis of a user utterance and a process corresponding to the response is executed is described in Patent Literature 1.

### CITATION LIST

### Patent Literature

Patent Literature 1: Japanese Unexamined Patent Application Publication No. 2017-527844

### DISCLOSURE OF INVENTION

### Technical Problem

It is an object of the present technology to make it possible to perform a process corresponding to user input satisfactorily.

### Solution to Problem

A concept of the present technology is an information processing apparatus including: an intention interpretation unit that interprets intention of user input;

a request issuing unit that issues a request corresponding to the interpreted intention; and

a local processing control unit that determines, on the basis of the issued request, whether a process corresponding to the request is to be executed by a local processing execution unit or by a cloud processing execution unit, and transmits, in a case where it is determined that the process is to be executed by the cloud processing execution unit, the request to a cloud processing control unit.

In the present technology, the intention interpretation unit interprets the intention of user input. The request issuing unit issues a request corresponding to the interpreted intention. Then, the local processing control unit determines, on the basis of the issued request, whether the process corresponding to this request is to be executed by the local processing execution unit or by the cloud processing execution unit, and transmits, in a case where it is determined that the process is to be executed by the cloud processing execution unit, the request to the cloud processing control unit. For example, the local processing control unit may receive, in a case where the request is transmitted to the cloud processing control unit, a response corresponding to the request from the cloud processing control unit.

For example, the local processing control unit may transmit an app request included in the response to the request issuing unit, and the request issuing unit may issue, in a case where the app request is received, a request including app-specifying information included in this app request. In this way, it is possible to perform a process corresponding to the request sequentially in a specified app.

In this case, for example, the app-specifying information included in the app request may specify an app relating to generation of the response again. This makes it possible to perform a response to a request in a plurality of stages, e.g., in two stages, and perform the first-stage response immediately on a user even if the process corresponding to the request takes a long time. For example, the response including the app request may be issued by the cloud processing control unit.

Further, for example, a rendering unit that outputs a voice or video signal on the basis of response information included in the response may be further provided. Then, in this case, for example, the rendering unit may stop, in a case where response information corresponding to a second request is transmitted during outputting of a voice or video signal corresponding to a first request, the outputting of the voice or video signal corresponding to the first request, and start outputting of a voice or video signal corresponding to the second request. This allows, in a case where there is an interrupt of user input, the voice or video of the response to the interrupt to be preferentially output.

As described above, in the present technology, whether a process corresponding to an issued request is performed by the local processing execution unit or by the cloud processing execution unit is determined on the basis of the issued request, and the request is transmitted to the cloud processing control unit in the case where it is determined that the process is to be performed by the cloud processing execution unit. Therefore, the process corresponding to user input can be performed in cooperation with the local processing execution unit and the cloud processing execution unit satisfactorily.

### Advantageous Effects of Invention

In accordance with the present technology, the process corresponding to user input can be performed satisfactorily. It should be noted that the effects described here are not necessarily limitative, and any of the effects described in the present disclosure may be provided.

### BRIEF DESCRIPTION OF DRAWINGS

FIG. 1 is a block diagram showing a configuration example of an information processing apparatus according to an embodiment.

FIG. 2 is a diagram showing an example of the sequence of a 2-stage response.

FIG. 3 is a diagram showing an example of the sequence of an interrupt during response reproduction after dispatching.

FIG. 4 is a diagram showing an example of the sequence of the interrupt during dispatching.

FIG. 5 is a diagram showing an example of the sequence of the interrupt and overtaking during dispatching.

FIG. 6 is a diagram showing an example of the sequence of the interrupt (case where the response is ignored) during response reproduction after dispatching.

FIG. 7 is a diagram showing an example of the sequence of the interrupt (case where the response is ignored) during dispatching.

FIG. 8 is a diagram showing an example of the sequence of the interrupt and overtaking (case where the response is ignored) during dispatching.

FIG. 9 is a diagram schematically showing an example of the sequence of an interrupt for the 2-stage response.

FIG. 10 is a diagram schematically showing an example of the sequence of the interrupt for the 2-stage response.

FIG. 11 is a diagram showing an example of the sequence of the interrupt during the 2-stage response.

FIG. 12 is a diagram showing an example of the sequence of the interrupt during the 2-stage response.

FIG. 13 is a diagram showing an example of the sequence of the interrupt during the 2-stage response.

FIG. 14 is a diagram showing an example of the sequence of the interrupt during the 2-stage response.

FIG. 15 is a diagram showing an example of the sequence of a predetermined 2-stage response.

FIG. 16 is a diagram showing an example of the sequence in estimation of domain goals.

FIG. 17 is a diagram showing an example of the sequence in the estimation of domain goals.

FIG. 18 is a diagram showing an example of the sequence relating to a response after understanding that it is an interrupt.

### MODE(S) FOR CARRYING OUT THE INVENTION

Hereinafter, embodiments for carrying out the invention (hereinafter, referred to as “embodiments”) will be described. Note that description will be made in the following order.

1. Embodiment

2. Modified example

### 1. First Embodiment

[Information Processing Apparatus]

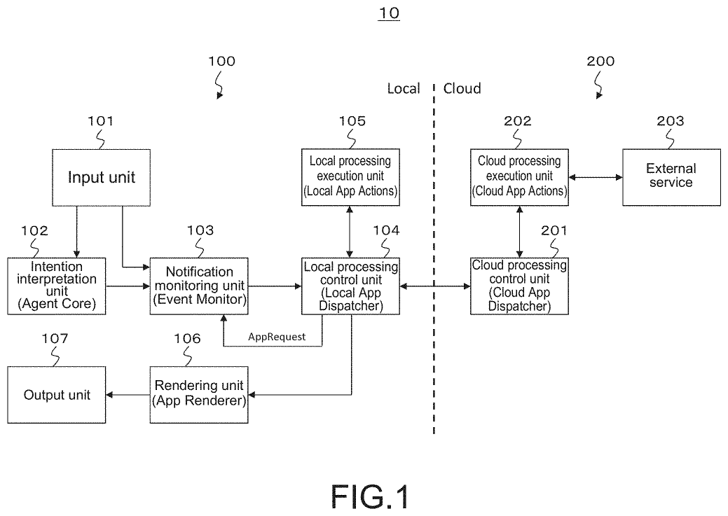

FIG. 1 shows a configuration example of an information processing apparatus 10 according to an embodiment. This information processing apparatus 10 includes a local-side processing apparatus 100 and a cloud-side processing apparatus 200. The local-side processing apparatus 100 includes an input unit 101, an intention interpretation unit (Agent Core) 102, a notification monitoring unit (Event Monitor) 103, a local processing control unit (Local App Dispatcher) 104, a local processing execution unit (Local App Actions) 105, a rendering unit (App Renderer) 106, and an output unit 107. Further, the cloud-side processing apparatus 200 includes a cloud processing control unit (Cloud App Dispatcher) 201, a cloud processing execution unit (Cloud App Actions) 202, and an external service 203.

The input unit 101 includes a microphone that detects utterance of a user, an image sensor that acquires surrounding image, a hardware key that allows the user to perform an input operation, a reception unit that receives notification from a network, and the like. The input unit 101 inputs, as a system event, key input information, notification information from the network, and other information to the notification monitoring unit 103.

Further, the input unit 101 transmits the utterance of the user detected by the microphone and the surrounding image acquired by the image sensor to the intention interpretation unit 102. The intention interpretation unit 102 performs speech recognition on the utterance of the user, interprets the intention thereof, and inputs an utterance event including the interpretation information to the notification monitoring unit 103. Further, the intention interpretation unit 102 performs image analysis on the surrounding image, interprets the intention thereof, and inputs a sensing event including the interpretation information to the notification monitoring unit 103.

The notification monitoring unit 103 issues, on the basis of various input events, an action request (ActionRequest), which is a request (Request) for app action (AppAction). In this sense, the notification monitoring unit 103 also constitutes a request issuing unit. This action request includes pieces of information of a type (type), intent (intent), and slot (slots). Note that the notification monitoring unit 103 issues an action request on the basis of also an app event by an app request (AppRequest) described below, and the action request further includes information of an app ID (appId).

The type indicates the event type. For example, in an action request of an utterance event, the event type is “speech”. Further, for example, in an action request of a system event, the event type is “system”. Further, for example, in an action request of an app event, the event type is “app”.

The intent indicates an intent in each event. For example, in the case where there is an utterance of “Tell me the time”, the intent is “CHECK-TIME”. Further, for example, in the case where there is an utterance of “Tell me the weather”, the intent is “WEATHER-CHECK”. Further, for example, in the case where the hardware key is pressed, the intent is “KEY-PRESSED”. The slots indicate information to supplement the intent.

For example, an example of the action request at the time of a user utterance of “Tell me the weather in Shinagawa today” is shown below.

type: “speech”
intent: “WEATHER-CHECK”
slots: { DATE-TIME: “2017/11/10 20:34:24”, PLACE:

“Shinagawa” }

Further, for example, an example of the action request at the time of a user utterance of “Set an alarm at 2 o'clock” is shown below.

type: “speech”
intent: “SET-ALARM”
slots: { DATE-TIME: “2017/11/10 14:00:00”}

On the basis of the action request issued by the notification monitoring unit 103, the local processing control unit 104 determines whether the process corresponding to this action request is executed by the local processing execution unit 105 or the cloud processing control unit 201 makes a decision. In the case where the local processing execution unit 105 is capable of performing the process, the local processing control unit 104 determines that the process is to be executed by the local processing execution unit 105 and transmits an action request to the local processing execution unit 105. Then, the local processing control unit 104 receives, from the local processing execution unit 105, an action response (ActionResponse), which is a response (Response) of the app action (AppAction).

The local processing control unit 104 has a correspondence table regarding “when an action request including this intent is received, the process is to be executed by this app action present in the local processing execution unit 105”. Therefore, in the case where the correspondence table includes an intent included in an action request received from the notification monitoring unit 103, the local processing control unit 104 determines that the process is to be executed by the local processing execution unit 105, and transmits the action request to the corresponding app action for processing. Note that the app action on the local side does not form an app as an aggregate like the app action on the cloud side described below, and each app action exists on its own.

Further, in the case where the correspondence table does not include the intent included in the action request received from the notification monitoring unit 103, the local processing control unit 104 delegates the decision to the cloud side, i.e., the cloud processing control unit 201, and transmits an action request to the cloud processing control unit 201.

The local processing control unit 104 causes the local processing execution unit 105 to execute, for example, action that operates even in an Internet non-connected environment, action to perform rendering immediately (visual feedback of the sensing status, etc.), and action that operates in a dedicated mode (system updates, Wifi AP connection, feedback for startup, user registration app, etc.). For example, processes specialized on the local side such as the process of increasing and decreasing the volume are performed by the local processing execution unit 105.

After transmitting the action request to the cloud processing control unit 201, the local processing control unit 104 receives an action response (ActionResponse) from the cloud control unit 201.

The action response includes pieces of information of an output speech (outputSpeech), output visual (outputVisual), and app request (appRequest). The output speech is information (voice response information) for presenting a response by voice. For example, text data of a response sentence such as “Display today's weather” for an utterance of “Tell me the weather today” corresponds to the output speech.

The output visual is information (screen response information) for presenting a response in video, and is provided in a text-based data format, for example. The app request indicates an app execution request for the purpose of cooperation between app actions.

For example, an example of the action response at the time of a user utterance of “Tell me the weather in Shinagawa today” is shown below.

outputSpeech: “Display today's weather”

outputVisual: <Layout information & data for creating display>

Further, the app request of the action response includes pieces of information of an app ID (appId), intent (intent), slot (slots), and delay (delay). The app ID indicates app-specifying information that specifies to which app the action request is issued. The intent indicates information of the intent included in the action request. The slot indicates information of slots included in the action request. The delay indicates a delay time until the action request is issued.

For example, an example of recalling its own app action with the same parameters as those in the received action request is shown below. By generating an app request for an action response as in this example, a 2-stage response described later is realized.

appId: <app ID of its own app>

intent: <Intent in ActionRequest>

slots: <slots in ActionRequest>

delay: 0

Further, the local processing control unit 104 transmits response information (output speech, output visual) included in the action response to the rendering unit 106. The rendering unit 106 performs rendering (sound effects, speech synthesis, animation) on the basis of the response information, and transmits the generated voice signal and video signal to the output unit 107. The output unit 107 includes a voice output device such as a speaker and a video output device such as a projector, and outputs voice and video by a voice signal and a video signal.

Note that the rendering unit 106 stops, in the case where, during outputting of a voice signal or a video signal corresponding to a first action request, response information corresponding to a subsequent second action request is transmitted from the local processing control unit 104, the outputting of the voice signal or the video signal corresponding to the first action request, and starts outputting of a voice signal or a video signal corresponding to the second action request. As a result, in the case where there is an interrupt of user input, it is possible to preferentially output the voice or video of the response to the interrupt.

The local processing control unit 104 transmits, in the case where the action response includes an app request, this app request to the notification monitoring unit 103 as an app event. The notification monitoring unit 103 issues, on the basis of this app event, an action request after the delay time indicated by the delay has elapsed. As described above, this action request includes information of an app ID (appId) as well as pieces of information of a type (type), intent (intent), and slot (slots). Here, the pieces of information of the intent, slot, and app ID are equal to those included in the app request.

The cloud processing control unit 201 receives an action request transmitted from the local processing control unit 104 and transmits the action request to the cloud processing execution unit 202. The cloud processing execution unit 202 includes a plurality of apps (cloud apps). Here, the app is a collection of related app actions, and is a collection of a plurality of app actions. For example, an app action that processes “CHECK-TIME” and app action that processes “SET-ALARM” are included in a clock (Clock) app.

Further, the app action is an execution unit called correspondingly to the intent, and is a function that receives an action request and returns an action response. The app action returns, as response information, information obtained by accessing the external service 203 such as web API in some cases.

The cloud processing control unit 201 uniquely determines, on the basis of information of the intent included in the action request transmitted from the local processing control unit 104, which app action executes this action request. Further, if the type of the action request indicates an utterance event and the slot information of the utterance has a lack that can be complemented or has ambiguous content, the cloud processing control unit 201 resolves this lack or ambiguity of this slot information.

For example, the cloud processing control unit 201 is capable of recognizing the currently displayed screen information from the content of the action response returned most recently. In the case where there is insufficient information such as time and place in the slot when information such as time and place is displayed on the screen, this is complemented. Further, also in the case where when an instruction word such as “Show me the weather here” is included in a user utterance, this is supplemented similarly on the basis of the displayed information. Further, a word having a plurality of interpretations is resolved on the basis of the dialogue history. For example, if a user asked “Tell me the weather in Osaki” in previous dialogues and the user rephrased “Osaki Station” after the weather in “Osaki City” is presented, knowledge that Osaki represents Osaki Station is held inside the cloud processing control unit 201 and used for subsequent resolution of slots.

The cloud processing control unit 201 transmits the action request transmitted from the local processing control unit 104 to the app action uniquely determined as described above, which is present in the cloud processing execution unit 202. Further, the cloud processing control unit 201 receives an action response including response information and the like from the app action that has processed the action request, and transmits the received action response to the local processing control unit 104.

The cloud processing control unit 201 has a correspondence table regarding which intent is received for each app and the app action to be called.

The cloud processing control unit 201 determines which app action to execute the action request transmitted from the local processing control unit 104 by performing the process in the following order.

(1) In the case where the action request includes an app ID that is app-specifying information, refer to the correspondence table of the app specified by the app ID.

(2) Otherwise, refer to the correspondence table of the foreground (Foreground) app, i.e., the app that has last displayed the screen. For example, in the case where there is an utterance of “Show me the weather”, a screen of the weather is displayed. In this case, the weather app becomes the foreground app.

(3) Otherwise, refer to the correspondence table of the specially prepared common (Common) app. The cloud processing control unit 201 also has a correspondence table of this common app. This correspondence table is used to specify app action that processes common operations such as returning to the previous screen display with the utterance of “Back”.

(4) Otherwise, refer to the default correspondence table. This default correspondence table shows the correspondence between the intent and the app separately from the correspondence table for each app. In practice, the app action is determined by referring to the correspondence table of the app obtained in this default correspondence table.

Note that there are cases where the app action that executes the action request transmitted from the local processing control unit 104 cannot be determined finally. In this case, the cloud processing control unit 201 transmits an action response including error information to the local processing control unit 104.

“2-Stage Response”

The “2-stage response” will be described. For example, in the case where there is a user utterance of “Show me the schedule”, the corresponding app action on the cloud side makes an inquiry to the external calendar service, and thus, it takes time to generate an action response based on the response from the external calendar service.

This 2-stage response is a revised response for a process that takes time to generate the response content. In this 2-stage response, in the first stage, the app action immediately returns the content that can be returned immediately, and recalls itself by the app request at the same time. In the second stage, a response relating to a time-consuming process is made.

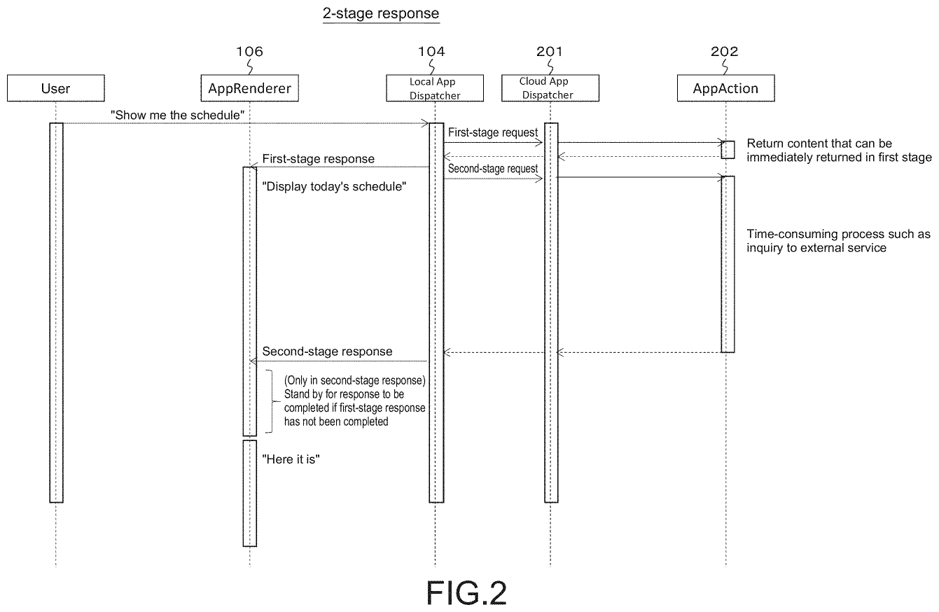

FIG. 2 shows an example of the sequence of the 2-stage response. In this example, illustration of the intention interpretation unit 102 and the notification monitoring unit 103 is omitted for simplicity. In the case where there is a user utterance of “Show me the schedule”, the action request (first stage) of the utterance event is transmitted from the local processing control unit 104 to the cloud processing control unit 201, and this action request is further transmitted to the corresponding app action in the cloud processing execution unit 202.

In this app action, a first-stage action response including voice response information of “Show today's schedule” and an app request for recalling itself is generated, and this action response is transmitted to the local processing control unit 104 via the cloud processing control unit 201 as indicated by the dashed line.

The voice response information included in the first-stage action response is transmitted to the rendering unit 106 for rendering, and the voice output (response reproduction) of “Display today's schedule” is started as a first-stage response. Further, the action request (second stage) of the app event by the app request included in the action response is transmitted to the cloud processing control unit 201, and this action request is further transmitted to the corresponding app action in the cloud processing execution unit 202.

In this app action, a second-stage action response including voice response information of “Here it is” and the screen response information of the calendar with schedules is generated after a time-consuming process such as an inquiry to an external service is performed, and this action response is transmitted to the local processing control unit 104 via the cloud processing control unit 201 as indicated by the dashed line.

The voice response information and screen response information included in this second-stage action response are transmitted to the rendering unit 106 for rendering, and the voice output of “Here it is” is started and the display of the calendar screen is started as the second-stage response in the state where the first-stage response is completed.

“Case where using 2-stage response is better” A case where using a 2-stage response is better will be described. The 2-stage response is effective in a case where it takes time to generate a response, such as the following.

(1) Case where API (Application Programming Interface) of external service, which might take a long time, is executed inside app action.

The reasons for taking a long time vary depending on the circumstances on the external service side, but can include, for example, that the server is poor and the process for a request is slow (problem of resources on the external service side), and that an inherently time-consuming process is requested (query for a large-scale database).

(2) Case where complex and time-consuming operation is performed inside app action.

It is conceivable to, for example, perform semantic analysis on a wording text of a user utterance, perform secondary analysis for response generation (e.g., internally using machine learning) on the basis of a response(s) from an external service(s), generate and process an image for screen-response at a pixel level (internally perform an image process), and access a large-scale database inside the app action.

(3) Case where process with some waiting time needs to be performed inside app action.

It is conceivable to, for example, intentionally sleep in the app action in order to delay the response to a user utterance.

“Generation of first-stage response” The generation of a first-stage response will be described. What response is performed in the first stage can be freely determined depending on the implementation on the app action side. However, considering the nature of the 2-stage response of delaying the time-consuming process and performing a response at the second stage, it is desirable to return the first-stage response as follows.

(1) Return what can be immediately returned.

In this case, a response is returned on the basis of the input information only.

(2) Inform user that request has been correctly accepted.

In this case, the request content of a user is repeated (mirroring) or the specific request content is put in the response statement, such as the date and time, location, and schedule name.

Further, the following is not essential, but it is desirable to consider it in order to obtain a more natural response.

(1) Prepare plurality of response patterns and return appropriate one (because performing fixed response each time gives mechanical impression).

In this case, a response pattern is selected at random or prioritized on the basis of the user attributes such as age/gender of the utterance user and selected.

(2) Adjust tone of response to normal tone of utterance user.

In this case, the word is adjusted to “ . . . right“for a user who says” . . . right?”, and the word is adjusted to “ . . . is“for a user who says” . . . isn't it?”

“Interrupt”

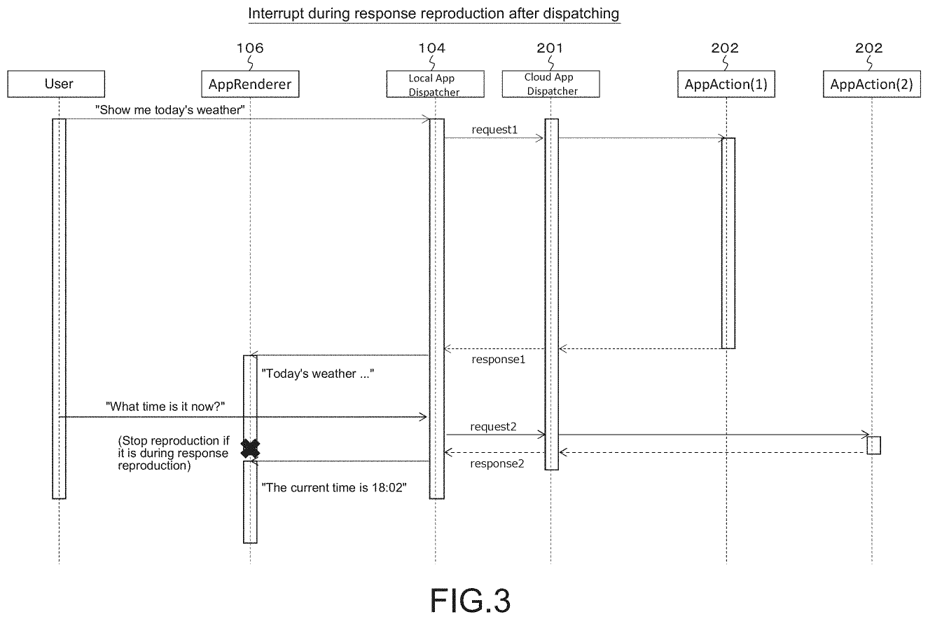

The interrupt will be described. In the case where there is an interrupt of user input, the voice or video of the response corresponding to the interrupt is preferentially output. The basic behavior to a speech interrupt will be described. FIG. 3 shows an example of the sequence of an interrupt during response reproduction after dispatching. In this example, illustration of the intention interpretation unit 102 and the notification monitoring unit 103 is omitted for simplicity. This also applies to the following sequence example.

In the case where there is a user utterance of “Show me today's weather”, the local processing control unit 104 transmits an action request “request 1” of the utterance event to the cloud processing control unit 201, and this action request “request 1” is further transmitted to the corresponding app action (1) of the cloud processing execution unit 202.

In this app action (1), the process corresponding to the action request “request 1” is executed, an action response “response 1” including the voice response information of “Today's weather . . . ” is generated, and this action response “response 1” is transmitted to the local processing control unit 104 via the cloud processing control unit 201. The voice response information included in the action response “response 1” is transmitted to the rendering unit 106 for rendering, and the output (reproduction) of the response voice of “Today's weather . . . ” is started.

In the case where “What time is it now?” is uttered by the same user or a different user during the outputting of the response voice, the local processing control unit 104 transmits an action request “request 2” of the utterance event to the cloud processing control unit 201, and this action request “request 2” is further transmitted to the corresponding app action (2) of the cloud processing execution unit 202.

In this app action (2), the process corresponding to the action request “request 2” is executed, an action response “response 2” including voice response information of “The current time is 18:02” is generated, and this action response “response 2” is transmitted to the local processing control unit 104 via the cloud processing control unit 201.

The voice response information included in this action response “response 2” is transmitted to the rendering unit 106 for rendering, and outputting of a response voice of “The current time is 18:02” is started. Note that if outputting of the response voice for the action request “request 1” has been continued at this time point, it is interrupted.

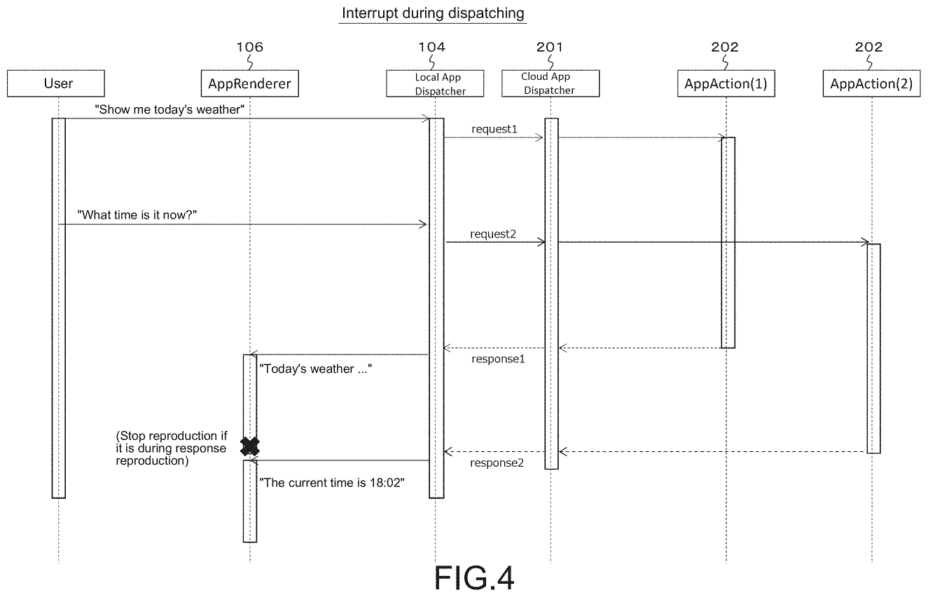

FIG. 4 shows an example of the sequence of an interrupt during dispatching. In the case where there is a user utterance of “Show me today's weather”, the local processing control unit 104 transmits the action request “request 1” of the utterance event to the cloud processing control unit 201, and this action request “request 1” is further transmitted to the corresponding app action (1) of the cloud processing execution unit 202.

Further, in the case where “What time is it now” is uttered by the same user or a different user, the local processing control unit 104 transmits the action request “request 2” of the utterance event to the cloud processing control unit 201, and this action request “request 2” is further transmitted to the corresponding app action (2) of the cloud processing execution unit 202.

In the app action (1), the process corresponding to the action request “request 1” is executed, the action response “response 1” including the voice response information of “Today's weather . . . ” is generated, and this action response “response 1” is transmitted to the local processing control unit 104 via the cloud processing control unit 201. The voice response information included in this action response “response 1” is transmitted to the rendering unit 106 for rendering, and the output (reproduction) of the response voice of “Today's weather . . . ” is started.

Further, in the app action (2), the process corresponding to the action request “request 2” is executed, the action response “response 2” including voice response information of “the current time is 18:02” is generated, and the action response “response 2” is transmitted to the local processing control unit 104 via the cloud processing control unit 201.

The voice response information included in this action response “response 2” is transmitted to the rendering unit 106 for rendering, and outputting of a response voice of “The current time is 18:02” is started. Note that if outputting of the response voice for the action request “request 1” has been continued at this time point, it is interrupted.

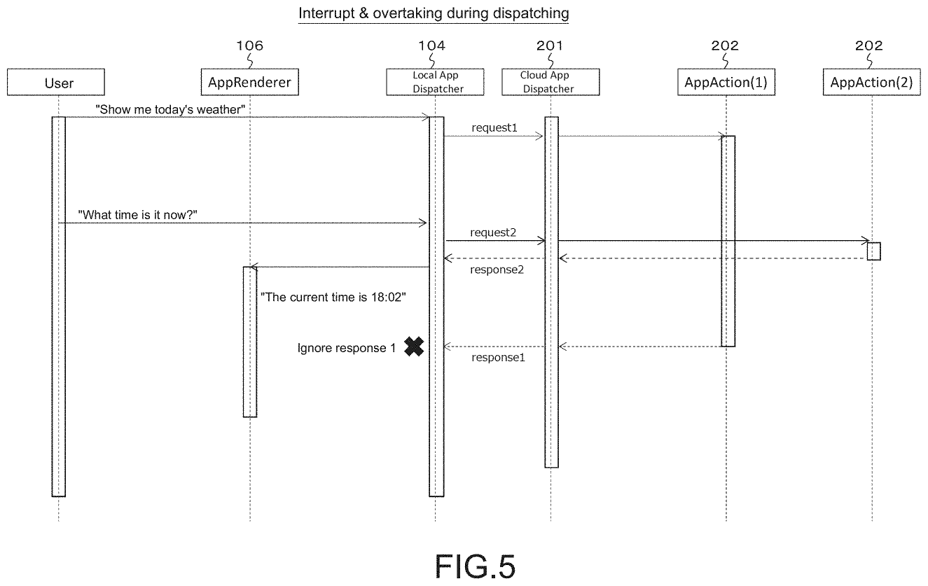

FIG. 5 shows an example of the sequence of the interrupt and overtaking during dispatching. In the case where there is a user utterance of “Show me today's weather”, the local processing control unit 104 transmits the action request “request 1” of the utterance event to the cloud processing control unit 201, and this action request “request 1” is further transmitted to the corresponding app action (1) of the cloud processing execution unit 202.

Further, in the case where “What time is it now” is uttered by the same user or a different user, the local processing control unit 104 transmits the action request “request 2” of the utterance event to the cloud processing control unit 201, and this action request “request 2” is further transmitted to the corresponding app action (2) of the cloud processing execution unit 202.

In the app action (2), the process corresponding to the action request “request 2” is executed, the action response “response 2” including voice response information of “the current time is 18:02” is generated, and this action response “response 2” is transmitted to the local processing control unit 104 via the cloud processing control unit 201. The voice response information included in this action response “response 2” is transmitted to the rendering unit 106 for rendering, and outputting (reproduction) of a response voice of “The current time is 18:02” is started.

Further, in the app action (1), the process corresponding to the action request “request 1” is executed, the action response “response 1” including the voice response information of “Today's weather . . . ” is generated, and this action response “response 1” is transmitted to the local processing control unit 104 via the cloud processing control unit 201. Outputting of the response voice for the action request “request 2” has already been started at this time point, and the local processing control unit 104 knows this, so that the action response “response 1” for this action request “request 1” is ignored.

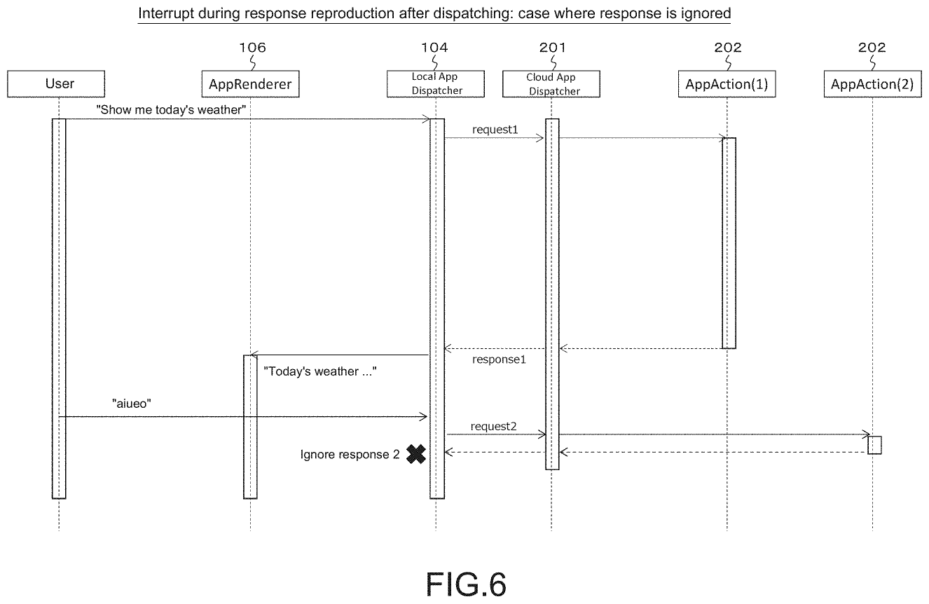

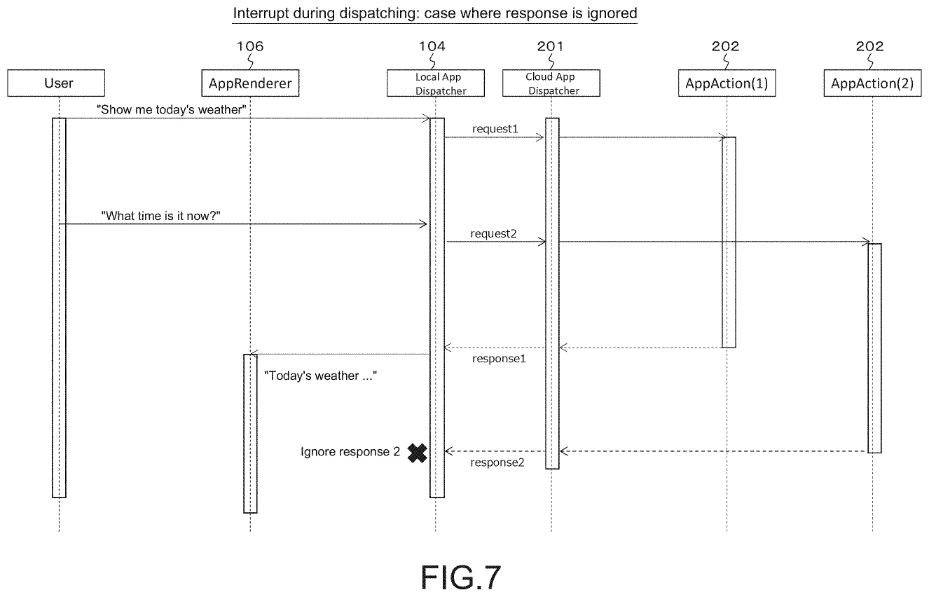

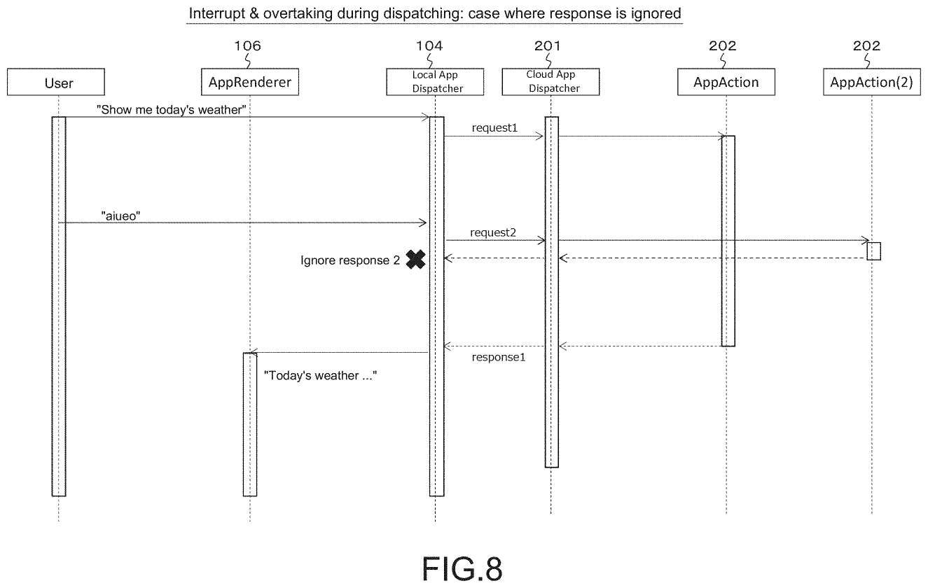

FIG. 6, FIG. 7, and FIG. 8 respectively show an example of the sequence of the pattern similar to those in FIG. 3, FIG. 4, and FIG. 5, but the action response “response 2” is ignored even in the case where it is an error response in these sequences. In this case, the action request “request 2” does not affect the behavior relating to the action request “request 1”.

The action response “response 2” becomes an error response, in the case where, for example, the process of the app action (2) for the action request “request 2” is executed but then an error occurs internally or the app action that processes the action request “request 2” cannot be determined. Note that although FIG. 6, FIG. 7, and FIG. 8 show that the action request “request 2” is transmitted from the cloud processing control unit 201 to the app action (2), the action request “request 2” is not transmitted to the app action (2) in the case where the cloud processing control unit 201 is unable to determine the app action that processes the action request “request 2”, and the action response “response 2” as an error response is generated by the cloud processing control unit 201.

“Interrupt for 2-Stage Response”

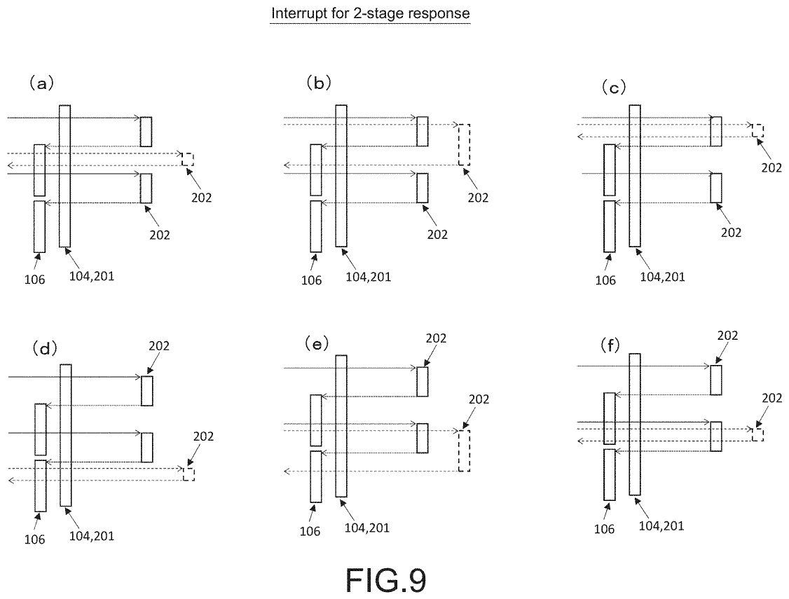

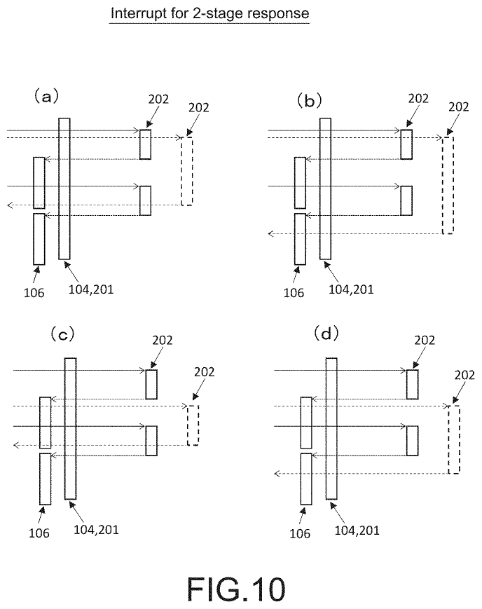

The interrupt for the 2-stage response will be described below. Parts (a) to (f) of FIG. 9 and Parts (a) to (d) of FIG. 10 each schematically show an example of the sequence of an interrupt for the 2-stage response. The dashed line indicates the behavior of the interrupt.

Parts (a), (b), and (c) of FIG. 9 each show a sequence example in the case where an interrupt similar to the sequence examples of FIG. 3, FIG. 4, and FIG. 5 is performed for the first stage. In this case, regardless of the 2-stage response, the first-stage response output (reproduction) is canceled at the time point when the action response for the interrupt action request is returned, and the second-stage action request is also canceled.

Parts (d), (e), and (f) of FIG. 9 each show a sequence example in the case where an interrupt similar to the sequence examples of FIG. 3, FIG. 4, and FIG. 5 is performed for the second stage. In this case, the second-stage action request is canceled at the time point when the action response for the interrupt action request is returned. Note that in this case, if the first-stage response output (reproduction) has been continued at the time point, it is naturally also canceled.

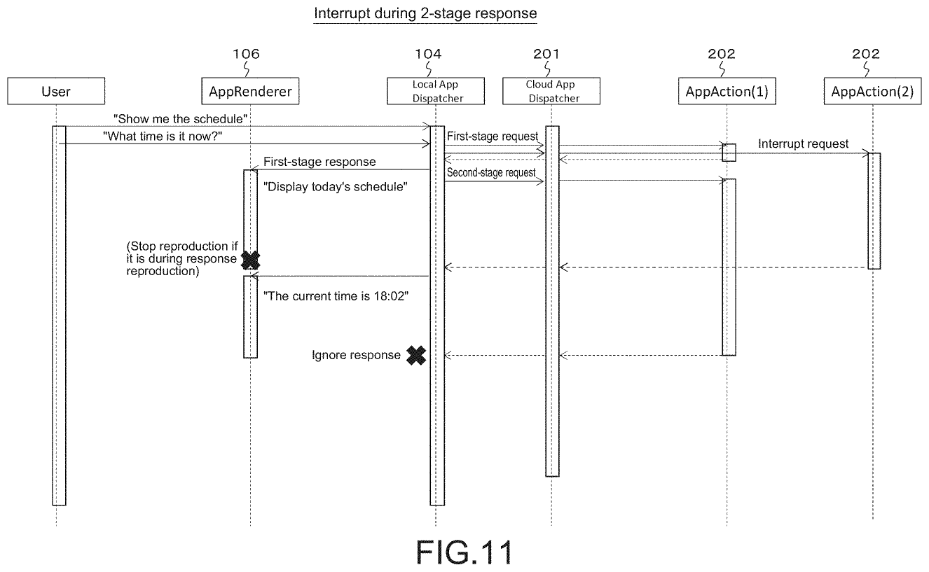

Parts (a) to (d) of FIG. 10 each show a sequence example in the case where an action request and an action response relating to an interrupt span the first stage and the second stage. FIG. 11 shows an example of the sequence of an interrupt during the 2-stage response corresponding to Part (a) of FIG. 10.

In the case where there is a user utterance of “Show me the schedule”, the local processing control unit 104 transmits an action request (the first-stage request) of the utterance event to the cloud processing control unit 201, and this action request is transmitted to the corresponding app action (1) in the cloud processing execution unit 202.

Further, in the case where “What time is it now” is uttered by the same user or a different user, the local processing control unit 104 transmits an interrupt request, which is the action request of the utterance event, to the cloud processing control unit 201, and this interrupt request is transmitted to the corresponding app action (2) in the cloud processing execution unit 202.

In the app action (1), a first-stage action response including voice response information of “Display today's schedule” and an app request to recall itself is generated, and this action response is transmitted to the local processing control unit 104 via the cloud processing control unit 201 as indicated by the dashed line.

The voice response information included in the first-stage action response is transmitted to the rendering unit 106 for rendering, and outputting (reproduction) of the response voice of “Display today's schedule” is started as a first-stage response. Further, the action request (second-stage request) for the app event by the app request included in the action response is transmitted to the cloud processing control unit 201, and this action request is transmitted to the corresponding app action (1) in the cloud processing execution unit 202.

In the app action (2), the process corresponding to the interrupt request is executed, an interrupt response, which is an action response including voice response information of “The current time is 18:02”, is generated, and this interrupt response is transmitted to the local processing control unit 104 via the cloud processing control unit 201 as indicated by the dashed line.

The voice response information included in this interrupt response is transmitted to the rendering unit 106 for rendering, and outputting of interrupt response voice of “The current time is 18:02” is started. Note that if outputting of the response voice of the first-stage action response has been continued at this time point, it is interrupted.

Further, in the app action (1), the process for the second-stage action request is executed, the second-stage action response is generated, and this action response is transmitted to the local processing control unit 104 via the cloud processing control unit 201 as indicated by the dashed line. Outputting of the response voice to the interrupt response has already been started at this time point, and the local processing control unit 104 knows this, so that this action response is ignored.

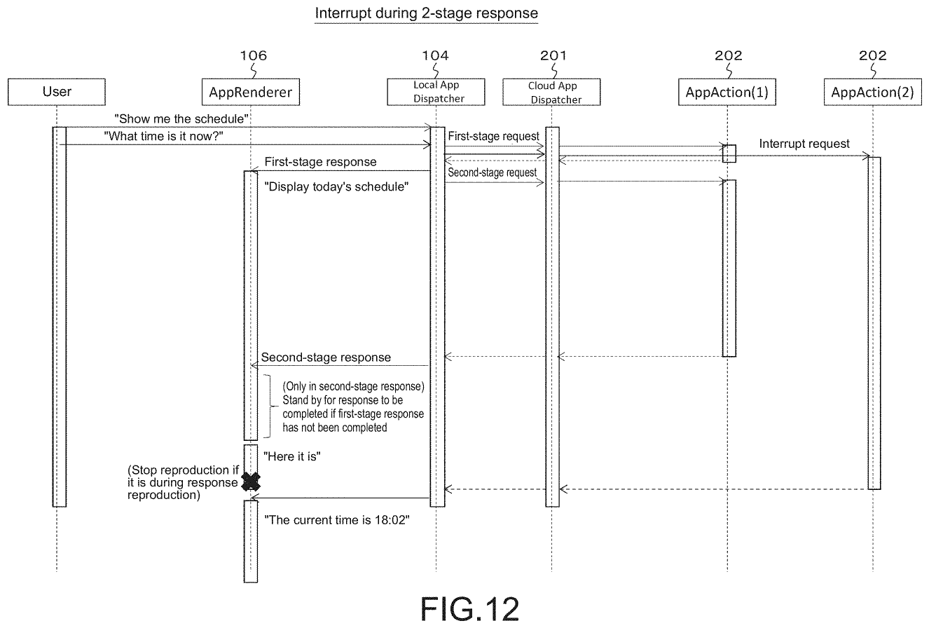

FIG. 12 shows an example of the sequence of an interrupt during the 2-stage response corresponding to Part (b) of FIG. 10.

In the case where there is a user utterance of “Show me the schedule”, the local processing control unit 104 transmits an action request (first-stage request) of the utterance event to the cloud processing control unit 201, and this action request is further transmitted to the corresponding app action (1) in the cloud processing execution unit 202.

Further, in the case where “What time is it now” is uttered by the same user or a different user, the local processing control unit 104 transmits an interrupt request, which is an action request of the utterance event, to the cloud processing control unit 201, and this interrupt request is further transmitted to the corresponding app action (2) in the cloud processing execution unit 202.

In the app action (1) a first-stage action response including voice response information of “Display today's schedule” and an app request to recall itself is generated, and this action response is transmitted to the local processing control unit 104 via the cloud processing control unit 201 as indicated by the dashed line.

The voice response information included in the first-stage action response is transmitted to the rendering unit 106 for rendering, and outputting (reproduction) of the response voice of “Display today's schedule” is started as a first-stage response. Further, the action request (second-stage request) of the app event by the app request included in this action response is transmitted to the cloud processing control unit 201, and this action request is further transmitted to the corresponding app action (1) in the cloud processing execution unit 202.

In this app action (1), a second-stage action response including voice response information of “Here it is” and the screen response information of the calendar with schedules is generated after a time-consuming process such as an inquiry to an external service is performed, and this action response is transmitted to the local processing control unit 104 via the cloud processing control unit 201 as indicated by the dashed line.

The voice response information and screen-response information included in this second-stage action response are transmitted to the rendering unit 106 for rendering, and the voice output of “Here it is” is started and the display of the calendar screen is started as the second-stage response in the state where the first-stage response is completed.

Further, in the app action (2), the process for the interrupt request is executed, an interrupt response, which is an action response including voice response information of “The current time is 18:02”, is generated, and this interrupt response is transmitted to the local processing control unit 104 via the cloud processing control unit 201 as indicated by the dashed line.

The voice response information included in this interrupt response is transmitted to the rendering unit 106 for rendering, and outputting of interrupt response voice of “The current time is 18:02” is started. Note that if outputting of the second-stage action response (voice, screen) has been continued at this time point, it is interrupted.

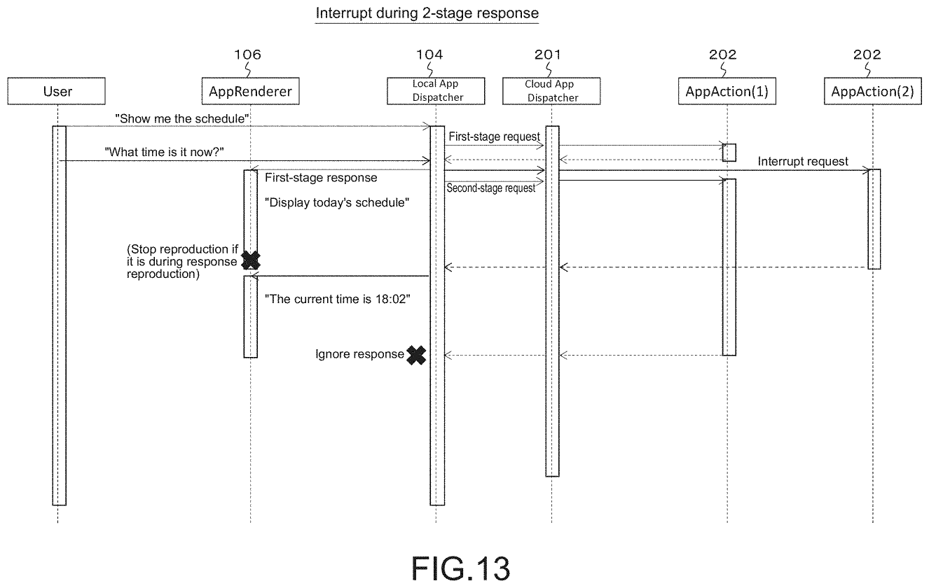

FIG. 13 shows an example of the sequence of an interrupt during the 2-stage response corresponding to Part (c) of FIG. 10.

In the case where there is a user utterance of “Show me the schedule”, the local processing control unit 104 transmits an action request (the first-stage request) of the utterance event to the cloud processing control unit 201, and this action request is further transmitted to the corresponding app action (1) in the cloud processing execution unit 202.

In the app action (1) a first-stage action response including voice response information of “Display today's schedule” and an app request to recall itself is generated, and this action response is transmitted to the local processing control unit 104 via the cloud processing control unit 201 as indicated by the dashed line.

Further, in the case where “What time is it now” is uttered by the same user or a different user, the local processing control unit 104 transmits an interrupt request, which is an action request of the utterance event, to the cloud processing control unit 201, and this interrupt request is further transmitted to the corresponding app action (2) in the cloud processing execution unit 202.

The voice response information included in the first-stage action response transmitted to the local processing control unit 104 is transmitted to the rendering unit 106 for rendering, and outputting (reproduction) of the response voice of “Display today's schedule” is started as a first-stage response. Further, the action request (second-stage request) for the app event by the app request included in this action response is transmitted to the cloud processing control unit 201, and this action request is further transmitted to the corresponding app action (1) in the cloud processing execution unit 202.

In the app action (2), the process for the interrupt request is executed, an interrupt response, which is an action response including voice response information of “The current time is 18:02”, is generated, and this interrupt response is transmitted to the local processing control unit 104 via the cloud processing control unit 201 as indicated by the dashed line.

The voice response information included in this interrupt response is transmitted to the rendering unit 106 for rendering, and outputting of interrupt response voice of “The current time is 18:02” is started. Note that if outputting of the response voice of the first-stage action response has been continued at this time point, it is interrupted.

Further, in the app action (1), the process for the second-stage action request is executed, the second-stage action response is generated, and this action response is transmitted to the local processing control unit 104 via the cloud processing control unit 201 as indicated by the dashed line. Outputting of the response voice to the interrupt response has already been started at this time point, and the local processing control unit 104 knows this, so that this action response is ignored.

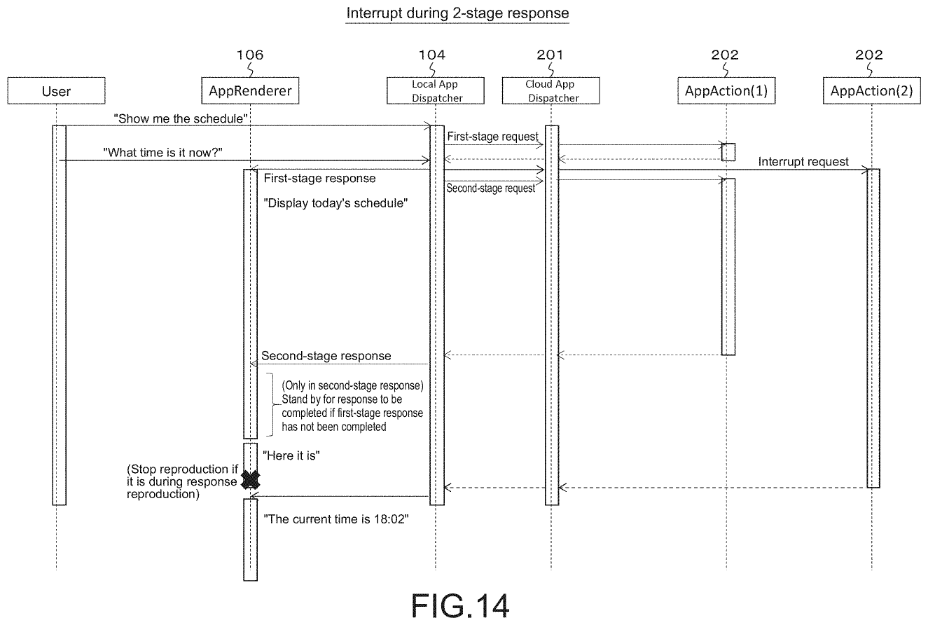

FIG. 14 shows an example of the sequence of an interrupt for the 2-stage response corresponding to Part (d) of FIG. 10.

In the case where there is a user utterance of “Show me the schedule”, the local processing control unit 104 transmits an action request (the first-stage request) of the utterance event to the cloud processing control unit 201, and this action request is further transmitted to the corresponding app action (1) in the cloud processing execution unit 202.

In the app action (1), a first-stage action response including voice response information of “Display today's schedule” and an app request to recall itself is generated, and this action response is transmitted to the local processing control unit 104 via the cloud processing control unit 201 as indicated by the dashed line.

Further, in the case where “What time is it now” is uttered by the same user or a different user, the local processing control unit 104 transmits an interrupt request, which is an action request of the utterance event, to the cloud processing control unit 201, and this interrupt request is transmitted to the corresponding app action (2) in the cloud processing execution unit 202.

The voice response information included in the first-stage action response transmitted to the local processing control unit 104 is transmitted to the rendering unit 106 for rendering, and outputting (reproduction) of the response voice of “Display today's schedule” is started as a first-stage response. Further, the action request (second-stage request) for the app event by the app request included in this action response is transmitted to the cloud processing control unit 201, and this action request is further transmitted to the corresponding app action (1) in the cloud processing execution unit 202.

In this app action (1), a second-stage action response including voice response information of “Here it is” and the screen response information of the calendar with schedules is generated after a time-consuming process such as an inquiry to an external service is performed, and this action response is transmitted to the local processing control unit 104 via the cloud processing control unit 201 as indicated by the dashed line.

The voice response information and screen response information included in this second-stage action response are transmitted to the rendering unit 106 for rendering, and the voice output of “Here it is” is started and the display of the calendar screen is started as the second-stage response in the state where the first-stage response is completed.

Further, in the app action (2), the process for the interrupt request is executed, an interrupt response, which is an action response including voice response information of “The current time is 18:02”, is generated, and this interrupt response is transmitted to the local processing control unit 104 via the cloud processing control unit 201 as indicated by the dashed line.

The voice response information included in this interrupt response is transmitted to the rendering unit 106 for rendering, and outputting of interrupt response voice of “The current time is 18:02” is started. Note that if outputting of the second-stage action response (voice, screen) has been continued at this time point, it is interrupted.

Note that in the interrupt for the 2-stage response described above, the existing behavior is not affected (see FIG. 2) in the case where the response (interrupt response) on the interrupting side is an error response and is ignored, similarly to the normal interrupt (see FIG. 6 to FIG. 8).

Note that regarding the 2-stage response described above, although it can be decided in advance in the designing time point of the app action that this app action performs a time-consuming process and thus performs the 2-stage response, the app action may be switched to a 2-stage response when it is found that the process is likely to be time-consuming, in the following manner.

For example, an app action sets a timer (e.g., 1 second) at the same time when receiving an action request. Then, the app action cancels the timer and returns an action response as usual once all necessary processes have been completed before the timer fires. Meanwhile, if the timer fires before all necessary processes are completed, the app action stops executing the necessary processes, switches the policy to the 2-stage response, and returns an action response corresponding to the first stage of the 2-stage response. Subsequent processes of the app action are the same as those in the case of the 2-stage response described above.

As described above, in the information processing apparatus 10 shown in FIG. 1, the local processing control unit 104 determines, on the basis of an action request issued by the notification monitoring unit 103, whether the process corresponding to this action request is executed by the local processing execution unit 105 or by the cloud processing execution unit 202, and transmits, where it is determined that the process is to be executed by the cloud processing execution unit 202, this action request to the cloud processing control unit 201. Therefore, the process corresponding to user input can be satisfactorily performed in cooperation with the local processing execution unit 105 and the cloud processing execution unit 202.

Further, in the information processing apparatus 10 shown in FIG. 1, an app request with app-specifying information can be included in the action response generated by the app action of the cloud processing execution unit 202, and the app including its own app action can be specified by the app-specifying information. Therefore, it is possible to perform a response to an action request in a plurality of stages, e.g., in two stages, and perform a first-stage response immediately for a user even in the case where the process corresponding to the action request takes a long time.

Further, in the information processing apparatus 10 shown in FIG. 1, the rendering unit 106 stops, in the case where response information corresponding to a second action request (interrupt request) is transmitted during outputting of voice or a video signal corresponding to a first action request, outputting of the voice or the video signal corresponding to the first action request, and starts outputting voice or a video signal corresponding to the second action request. Therefore, in the case where there is an interrupt of user input, the voice or video of the response to the interrupt can be preferentially output, and a natural interrupt response can be executed.

### 2. Modified Example

Note that although an example in which the app action also performs the first-stage response in the 2-stage response has been described in the above-mentioned embodiment, it is also conceivable that the first-stage response is performed by the cloud processing control unit 201. Hereinafter, the 2-stage response in which the first-stage response is performed by the cloud processing control unit 201 as described above will be referred to as a “predetermined two-stage response”. When using this predetermined two-stage response, the cloud processing control unit 201 may have, in the setting, a boolean value that indicates which intent is to be received to perform the predetermined two-stage response.

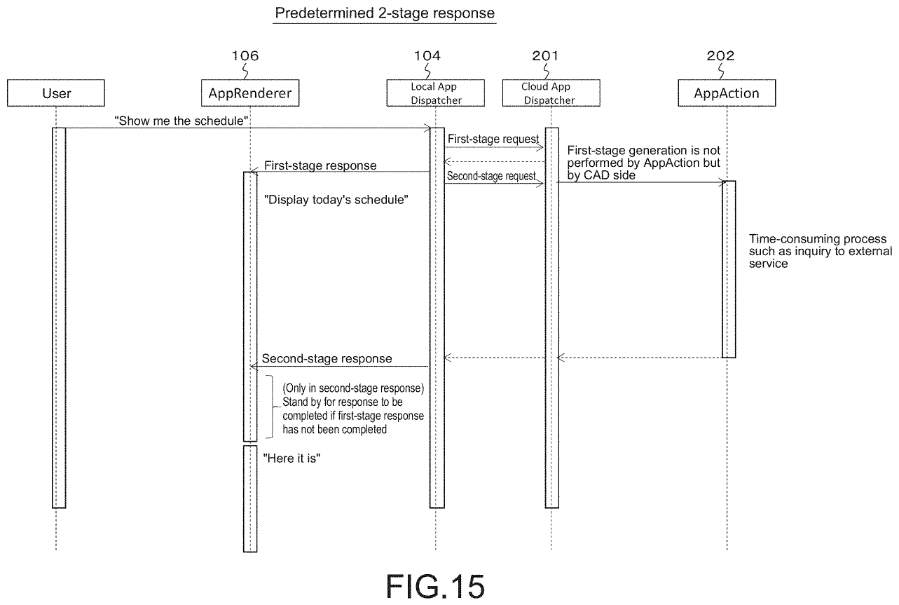

FIG. 15 shows an example of the sequence of the predetermined two-stage response. In this example, illustration of the intention interpretation unit 102 and the notification monitoring unit 103 is omitted for simplicity. In the case where there is a user utterance of “Show me the schedule”, the local processing control unit 104 transmits an action request (the first-stage request) of the utterance event to the cloud processing control unit 201.

The cloud control processor 201 determines, on the basis of information of the intent included in this action request, that the predetermined two-stage response is to be performed. Then, in the cloud control processing unit 201, a first-stage action response including voice response information of “Display today's schedule” which is a predetermined two-stage response corresponding to the intent, and an app request to call an app action for actually processing an action request is generated, and this action response is transmitted to the local processing control unit 104 via the cloud processing control unit 201 as indicated by the dashed line.

The voice response information included in the first-stage action response is transmitted to the rendering unit 106 for rendering, and the voice output (response reproduction) of “Display today's schedule” is started as a first-stage response. Further, an action request (second-stage request) of the app event by the app request included in the action response is transmitted to the cloud processing control unit 201, and this action request is further transmitted to the corresponding app action in the cloud processing execution unit 202.

In this app action, a second-stage action response including voice response information of “Here it is” and the screen response information of the calendar with schedules is generated after a time-consuming process such as an inquiry to an external service is performed, and this action response is transmitted to the local processing control unit 104 via the cloud processing control unit 201 as indicated by the dashed line.

The voice response information and screen response information included in this second-stage action response are transmitted to the rendering unit 106 for rendering, and the voice output of “Here it is” is started and the display of the calendar screen is started as the second-stage response in the state where the first-stage response is completed.

“Regarding Generation of First-Stage Response in Case of Using Predetermined Two-Stage Response”

Here, the generation of the first-stage response in the case of using a predetermined two-stage response will be described. In the case of using a predetermined two-stage response, since the first-stage response is performed by the cloud processing control unit 201 which is a shared portion, the content of the response needs to be devised. The generation of the first-stage response in the predetermined two-stage response can be performed by randomly selecting one of the following patterns.

(1) Method Based on User Utterance

A response is generated by mirroring including a user utterance such as “{user utterance}, isn't it?” and “I understand that (user utterance)”.

(2) Method Base on Intent A response is generated by the words (which may include a plurality of variations) fixedly assigned to the intent, such as “It is weather, isn't it?” in the case of “intent=WEATHER-CHECK” and “It is addition of schedule, isn't it?” in the case of “intent=SCHEDULE−ADD”.

(3) Method Based on Intent+Slot

A response is generated by the words (which may include a plurality of variations) assigned to the intent+slot, such as “It is today's weather, isn't it?”, in the case where “DATE=“today”” is inserted in the slot for “intent=WEATHER-CHECK”.

(4) Response Words that can be Used Generically

A response is generated by “I understand”, “OK”, “Please wait for a moment”, or the like.

Note that a priority for which pattern is prioritized may be specified on the app action side instead of selecting the pattern at uniform random. Further, in addition to the setting of “whether or not the predetermined two-stage response is to be performed”, the response content at that time may be passed as a setting on the application side. For example, a weather app sets the response content as “I'll be going to Dr. Weather for a minute now”. In this case, the cloud processing control unit 201 may use it as the response as it is, or may use it as one of the above-mentioned candidates. Further, the cloud processing control unit 201 may, for example, consider user attributes or adjust the tone, similarly to the first-stage response generation on the app action side in the normal 2-stage response.

Estimation of Domain Goals (Intent)

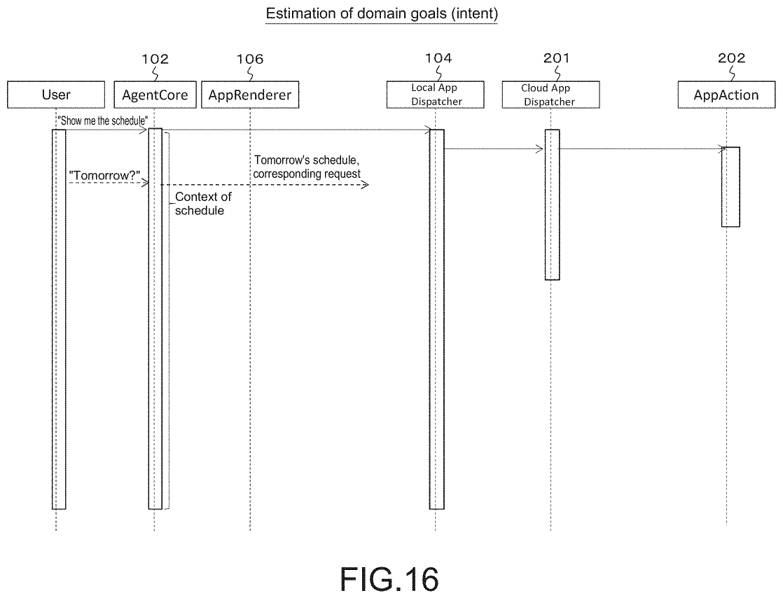

As described in the above-mentioned embodiments, speech recognition of an utterance of a user and interpretation of the intent of the utterance are performed by the intention interpretation unit (Agent Core) 102. Further, as shown in one example of the sequence of FIG. 16, user intentions for omitted utterances are also complemented by the dialog control function of the intention interpretation unit 102.

For example, in the case where a user makes an abbreviated utterance of “Tomorrow?” after the user utterance of “Show me the schedule”, the intention interpretation unit 102 also supplements the intent as “tomorrow's schedule.” As a result, in this case, the notification monitoring unit (Event Monitor) 103 issues an action request corresponding to the “tomorrow schedule”.

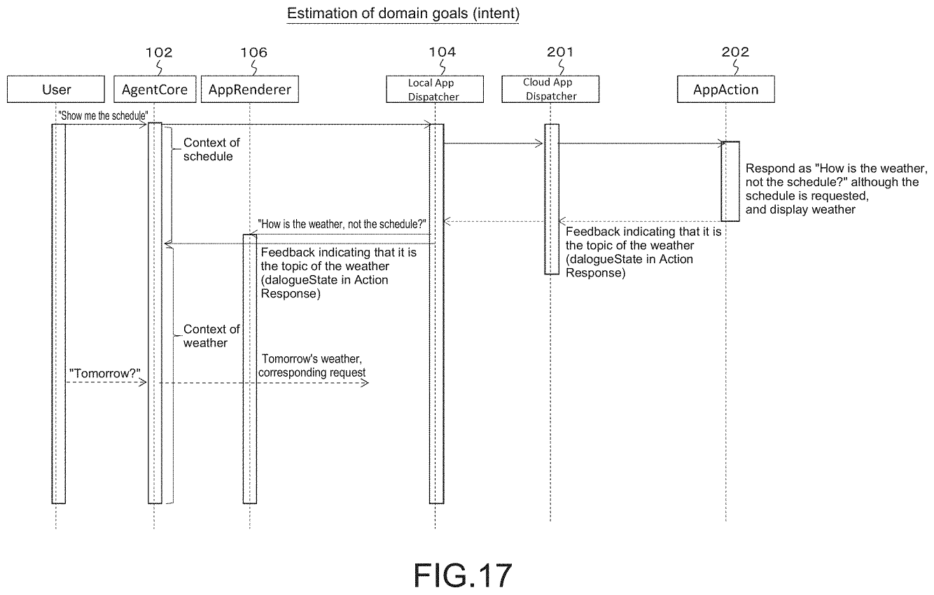

In the intention interpretation unit 102, the context is switched basically by the occurrence of another intended user utterance. Meanwhile, the context is switched by feedback from the app action side in some cases. FIG. 17 shows an example of the sequence in this case. Note that in this example, illustration of the notification monitoring unit 103 is omitted for simplicity.

In the case where there is a user utterance of “Show me the schedule”, the intention interpretation unit (Agent Core) 102 interprets the intent. In this case, the context of the intention interpretation unit 102 is switched to the “scheduled context”. The interpretation result of the intention interpretation unit 102 is transmitted to the notification monitoring unit (Event Monitor) 103, and an action request corresponding to “Show me the schedule” is issued. This action request is transmitted from the local processing control unit 104 to the cloud processing control unit 201, and is further transmitted to the corresponding app action in the cloud processing execution unit 202.

In the application action 202, the process of an action request is performed. In this case, an action response including voice information of “How is the weather, not the schedule?” and information of a feedback “dalogueState” indicating that it is the topic of the weather is generated although the schedule is requested, and this action response is transmitted to the local processing control unit 104 via the cloud processing control unit 201 as indicated by the dashed line.

The voice response information included in this action response is transmitted to the rendering unit 106 for rendering, and voice output of “How is the weather, not the schedule?” is started as a response. Further, the information of a feedback “dalogueState” indicating that it is the topic of the weather included in this action response is transmitted to the intention interpretation unit 102, and the context of this intention interpretation unit 102 is switched to the “weather context”.

In the case where the user then makes an abbreviated utterance of “Tomorrow?”, in the intention interpretation unit 102, the intent is supplemented as the “tomorrow's weather” on the basis of the “weather context” unlike the example of FIG. 16. As a result, the notification monitoring unit (Event Monitor) 103 issues an action request corresponding to the “tomorrow's weather”.

“Response after Understanding that it is Interrupt”

Next, a response after understanding that it is an interrupt will be described. The local processing control unit (Local App Dispatcher) 104 gives an “interrupt flag” in the following cases, for example.

(1) During dispatching for another user utterance or reproduction of response thereof

(2) During dispatching for another user utterance or reproduction of response thereof and in case where interrupted utterance and interrupting utterance have same intent

Further, the app action (App Action) is capable of changing the response content according to the interrupt flag. For example, in the case where an app action that displays the schedule receives a request for the “tomorrow's schedule”+interrupt flag, it is conceivable to perform a response such as “Oops, was it tomorrow? I understand” instead of performing a response of “It's tomorrow's schedule, isn't it?” if it is normal.

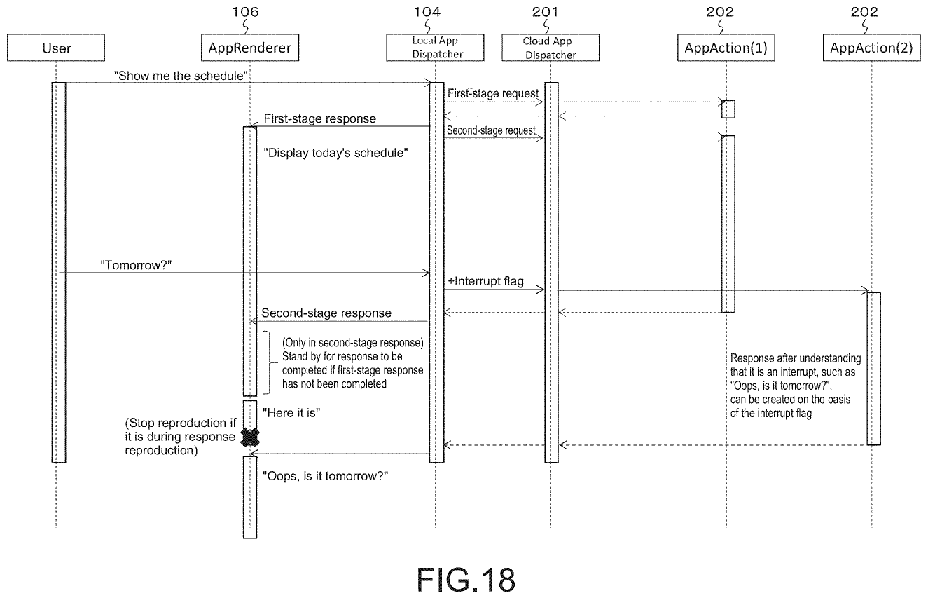

FIG. 18 shows an example of the sequence relating to a response after understanding that it is an interrupt. In the case where there is a user utterance of “Show me the schedule”, the local processing control unit 104 transmits an action request (the first-stage request) of the utterance event to the cloud processing control unit 201, and this action request is further transmitted to the corresponding app action (1) in the cloud processing execution unit 202.

In the app action (1), a first-stage action response including voice response information of “Display today's schedule” and an app request for recalling itself is generated, and this action response is transmitted to the local processing control unit 104 via the cloud processing control unit 201 as indicated by the dashed line.

The voice response information included in the first-stage action response transmitted to the local processing control unit 104 is transmitted to the rendering unit 106 for rendering, and outputting (reproduction) of the response voice of “Display today's schedule” is started as a first-stage response. Further, an action request (second-stage request) of the app event by the app request included in this action response is transmitted to the cloud processing control unit 201, and this action request is further transmitted to the corresponding app action (1) in the cloud processing execution unit 202.

Further, in the case where there is an utterance of “tomorrow” by the same user or another user, the local processing control unit 104 transmits an action request (interrupt request) of the utterance event to the cloud processing control unit 201, and is further transmitted to the corresponding app action (2). An interrupt flag indicating that it is an interrupt is added to this interrupt request.

In this app action (1), a second-stage action response including voice response information of “Here it is” and the screen response information of the calendar with schedules is generated after a time-consuming process such as an inquiry to an external service is performed, and this action response is transmitted to the local processing control unit 104 via the cloud processing control unit 201 as indicated by the dashed line.

The voice response information and screen response information included in this second-stage action response are transmitted to the rendering unit 106 for rendering, and the voice output of “Here it is” is started and the display of the calendar screen is started as the second-stage response in the state where the first-stage response is completed.

Further, in the app action (2), the process for the interrupt request is executed, and a response after understanding that it is an interrupt can be created on the basis of the interrupt flag. For example, an interrupt response, which is an action response including voice response information of “Oops, was it tomorrow?”, is generated, and this interrupt response is transmitted to the local processing control unit 104 via the cloud processing control unit 201 as indicated by the dashed line.

The voice response information included in this interrupt response is transmitted to the rendering unit 106 for rendering, and outputting of the interrupt response voice of “Oops, was it tomorrow?” is started. Note that if outputting of the second-stage action response (voice, screen) has been continued at this time point, it is interrupted.

Further, although an example in which a 2-stage response is performed using an app request (appRequest) included in an action response (ActionResponse) has been described in the above-mentioned embodiments, the response is not limited to two stages, and it is also conceivable to perform a response in three or more stages in the same manner. For example, the present technology is applicable to a case where it is desired to present information sequentially while switching screens. Further, in addition to calling the same app action again, it is also possible to sequentially call app actions including another app action and perform a stepwise response.

Further, the present technology may also take the following configurations.

(1) An information processing apparatus, including:

an intention interpretation unit that interprets intention of user input;

a request issuing unit that issues a request corresponding to the interpreted intention; and

a local processing control unit that determines, on a basis of the issued request, whether a process corresponding to the request is to be executed by a local processing execution unit or by a cloud processing execution unit, and transmits, in a case where it is determined that the process is to be executed by the cloud processing execution unit, the request to a cloud processing control unit.

(2) The information processing apparatus according to (1) above, in which

the local processing control unit receives, in a case where the request is transmitted to the cloud processing control unit, a response corresponding to the request from the cloud processing control unit.

(3) The information processing apparatus according to (2) above, in which

the local processing control unit transmits an app request included in the response to the request issuing unit, and

the request issuing unit issues, in a case where the app request is received, a request including app-specifying information included in the app request.

(4) The information processing apparatus according to (3) above, in which

the app-specifying information included in the app request specifies an app relating to generation of the response again.

(5) The information processing apparatus according to (4) above, in which

the response including the app request is issued by the cloud processing control unit.

(6) The information processing apparatus according to any one of (2) to (5) above, further including

a rendering unit that outputs a voice or video signal on a basis of response information included in the response.

(7) The information processing apparatus according to (6) above, in which

the rendering unit stops, in a case where response information corresponding to a second request is transmitted during outputting of a voice or video signal corresponding to a first request, the outputting of the voice or video signal corresponding to the first request, and starts outputting of a voice or video signal corresponding to the second request.

(8) An information processing method, including:

an intention interpretation step of interpretating, by an intention interpretation unit, intention of user input;

a request issuing step of issuing, by a request issuing unit, a request corresponding to the interpreted intention; and

a local processing control step of determining, by a local processing control unit, on a basis of the issued request, whether a process corresponding to the request is to be executed by a local processing execution unit or by a cloud processing execution unit, and transmitting, in a case where it is determined that the process is to be executed by the cloud processing execution unit, the request to a cloud processing control unit.

(9) The information processing method according to (8) above, in which

the local processing control unit receives, in a case where the request is transmitted to the cloud processing control unit, a response corresponding to the request from the cloud processing control unit.

(10) The information processing method according to (9) above, in which

the local processing control unit transmits an app request included in the response to the request issuing unit, and

the request issuing unit issues, in a case where the app request is received, a request including app-specifying information included in the app request.

(11) The information processing method according to (10) above, in which

the app-specifying information included in the app request specifies an app relating to generation of the response again.

(12) The information processing method according to (11) above, in which

the response including the app request is issued by the cloud processing control unit.

(13) The information processing method according to any one of (9) to (12) above, further including

a rendering step of outputting, by a rendering unit, a voice or video signal on a basis of response information included in the response.

(14) The information processing method according to (13) above, in which

the rendering unit stops, in a case where response information corresponding to a second request is transmitted during outputting of a voice or video signal corresponding to a first request, the outputting of the voice or video signal corresponding to the first request, and starts outputting of a voice or video signal corresponding to the second request.

(15) A program that causes a computer to function as:

an intention interpretation means of interpretating intention of user input;

a request issuing means of issuing a request corresponding to the interpreted intention; and

a local processing control means of determining, on a basis of the issued request, whether a process corresponding to the request is to be executed by a local processing execution unit or by a cloud processing execution unit, and transmitting, in a case where it is determined that the process is to be executed by the cloud processing execution unit, the request to a cloud processing control unit.

### REFERENCE SIGNS LIST

10 information processing apparatus
100 local-side processing apparatus
101 input unit
102 intention interpretation unit (Agent Core)
103 notification monitoring unit (Event Monitor)
104 local processing control unit (Local App Dispatcher)
105 local processing execution unit (Local App Actions)
106 rendering unit (App Renderer)
107 output unit
200 cloud-side processing apparatus
201 cloud processing control unit (Cloud App Dispatcher)
202 cloud processing execution unit (Cloud App Actions)
203 external service

1. An information processing apparatus, comprising:
an intention interpretation unit that interprets intention of user input;
a request issuing unit that issues a request corresponding to the interpreted intention; and
a local processing control unit that determines, on a basis of the issued request, whether a process corresponding to the request is to be executed by a local processing execution unit or by a cloud processing execution unit, and transmits, in a case where it is determined that the process is to be executed by the cloud processing execution unit, the request to a cloud processing control unit.

2. The information processing apparatus according to claim 1, wherein
the local processing control unit receives, in a case where the request is transmitted to the cloud processing control unit, a response corresponding to the request from the cloud processing control unit.

3. The information processing apparatus according to claim 2, wherein
the local processing control unit transmits an app request included in the response to the request issuing unit, and
the request issuing unit issues, in a case where the app request is received, a request including app-specifying information included in the app request.

4. The information processing apparatus according to claim 3, wherein
the app-specifying information included in the app request specifies an app relating to generation of the response again.

5. The information processing apparatus according to claim 4, wherein
the response including the app request is issued by the cloud processing control unit.

6. The information processing apparatus according to claim 2, further comprising
a rendering unit that outputs a voice or video signal on a basis of response information included in the response.

7. The information processing apparatus according to claim 6, wherein
the rendering unit stops, in a case where response information corresponding to a second request is transmitted during outputting of a voice or video signal corresponding to a first request, the outputting of the voice or video signal corresponding to the first request, and starts outputting of a voice or video signal corresponding to the second request.

8. An information processing method, comprising:
an intention interpretation step of interpretating, by an intention interpretation unit, intention of user input;
a request issuing step of issuing, by a request issuing unit, a request corresponding to the interpreted intention; and
a local processing control step of determining, by a local processing control unit, on a basis of the issued request, whether a process corresponding to the request is to be executed by a local processing execution unit or by a cloud processing execution unit, and transmitting, in a case where it is determined that the process is to be executed by the cloud processing execution unit, the request to a cloud processing control unit.

9. The information processing method according to claim 8, wherein
the local processing control unit receives, in a case where the request is transmitted to the cloud processing control unit, a response corresponding to the request from the cloud processing control unit.

10. The information processing method according to claim 9, wherein
the local processing control unit transmits an app request included in the response to the request issuing unit, and
the request issuing unit issues, in a case where the app request is received, a request including app-specifying information included in the app request.

11. The information processing method according to claim 10, wherein
the app-specifying information included in the app request specifies an app relating to generation of the response again.

12. The information processing method according to claim 11, wherein
the response including the app request is issued by the cloud processing control unit.

13. The information processing method according to claim 9, further comprising
a rendering step of outputting, by a rendering unit, a voice or video signal on a basis of response information included in the response.

14. The information processing method according to claim 13, wherein
the rendering unit stops, in a case where response information corresponding to a second request is transmitted during outputting of a voice or video signal corresponding to a first request, the outputting of the voice or video signal corresponding to the first request, and starts outputting of a voice or video signal corresponding to the second request.

15. A program that causes a computer to function as:
an intention interpretation means of interpretating intention of user input;
a request issuing means of issuing a request corresponding to the interpreted intention; and
a local processing control means of determining, on a basis of the issued request, whether a process corresponding to the request is to be executed by a local processing execution unit or by a cloud processing execution unit, and transmitting, in a case where it is determined that the process is to be executed by the cloud processing execution unit, the request to a cloud processing control unit.
